(19) United States
(12) Patent Application Publication
(10) Pub. No.: US 2022/0315611 A1
(43) Pub. Date: Oct. 6, 2022

(54) PREPARATION OF SILOXANES IN THE PRESENCE OF CATIONIC GERMANIUM(II) COMPOUNDS

(71) Applicant: Wacker Chemie AG, Munich (DE)

(72) Inventors: Elke Fritz-Langhals, Ottobrunn (DE); Richard Weidner, Burghausen (DE)

(73) Assignee: Wacker Chemie AG, Munich (DE)

(21) Appl. No.: 17/608,140

(22) PCT Filed: May 10, 2019
(86) PCT No.: PCT/EP2019/062023

§ 371 Date: Nov. 1, 2021

(51) Int. Cl. C07F 7/18; C07F 7/08; C07F 17/00; B01J 31/22

(52) U.S. Cl. CPC C07F 7/188; C07F 7/0896; C07F 7/1804; C07F 17/00; B01J 31/2295; B01J 2531/40; B01J 2231/005

(57) ABSTRACT

A mixture M includes at least one compound A selected from (a1) a compound of the general formula (I): R¹R²R³Si—H, and/or (a2) a compound of the general formula (I′): (SiO_{4/2})ₐ(R^{x}SiO_{3/2})_{b}(HSiO_{3/2})_{b′}(R^{x}₂SiO_{2/2})_{c}(R^{x}HSiO_{2/2})_{c′}(H₂SiO_{2/2})_{c″}(R^{x}₃SiO_{1/2})_{d}(HR^{x}₂SiO_{1/2})_{d′}(H₂R^{x}SiO_{1/2})_{d″}(H₃SiO_{1/2})_{d′″}, and at least one compound B selected from (b1) a compound of the general formula (II): R⁴R⁵R⁶Si—O—R⁷, and/or (b2) a compound of the general formula (II′): R^{x}₃Si—O[—SiR^{x}₂—O]ₘ—[Si(OR⁷₃)R^{x}—O]ₙ—SiR^{x}₃, and at least one compound C selected from the cationic germanium(II) compound of the general formula (III): ([Ge(II)Cp]⁺)ₐX^{a-}.

The invention relates to a process for the preparation of siloxanes from mixtures of hydrosilicon compounds and organosilicon compounds having an alkoxy group in the presence of a cationic germanium(II) compound, and also to said mixtures.

Various methods for preparing siloxane moieties are known. Especially common are condensations according to the scheme Si-OH+HO-Si—>Si—O-Si+H₂O, however the use of two different silanols results in a mixture of hetero- and homocondensation products. In this case, a uniform product cannot be produced. Selective linkage is achieved by noble metal-catalyzed dehydrocondensation of Si—H containing silanes or siloxanes and silanols (Si-H+OH—Si->Si—O—Si+H₂), but silanols are generally not storage-stable. An economic disadvantage is the use of expensive noble metal catalysts. Another possibility, described in US2004/012668, is the reaction of H-silanes or H-siloxanes with alkoxysilanes with elimination of hydrocarbons (Si—H+RO—Si->Si—O—Si+R—H) in the presence of tris (pentafluorophenyl)borane as catalyst, which is known as the Piers-Rubinsztajn reaction (MA Brook, Chem. Eur. J. 2018, 24, 8458). A disadvantage when using B(C₆F₅)₃ is that the catalyst is consumed during the reaction with the formation of catalytically inactive compounds, in particular dimethyl(pentafluorophenyl)silane. As a result, the reaction slows down and there is a risk that the reaction stops prematurely. Catalyst must then be added again. This complicates the process control considerably and diminishes the reproducibility of the reaction. The use of relatively large amounts of catalyst at the start of the reaction is not a solution to the problem, since this results in an unfavorable course of the process with a very rapid initial phase which, due to the exothermic nature of the reaction, is difficult to control technically and poses a considerable safety risk. In addition, the increased use of catalyst and consumption thereof by deactivation make the process considerably more expensive.

It is known from WO2019/068357 (COT 1720) that cationic silicon(II) compounds catalyze the reaction very efficiently and do not have the disadvantages observed when using B(C₆F₅)₃. However, in this case there is the problem of high sensitivity to air and moisture, which increases the technical complexity.

The object was therefore to provide a process for the preparation of siloxanes which does not have the disadvantages mentioned above.

This object is achieved by using cationic germanium(II) compounds in the presence of oxygen, which forms a highly active catalyst system that very efficiently catalyzes the Piers-Rubinsztajn reaction.

It has been found that cationic germanium(II) compounds catalyze Piers-Rubinsztajn reactions in the presence of oxygen. Cationic germanium(II) compounds are also stable as solids in air for several days. This is surprising since the corresponding silicon(II) compounds decompose very rapidly in air. This represents another considerable technical advantage of the germanium(II) compounds in Piers-Rubinsztajn reactions.

The present invention relates to a mixture M comprising

(a) at least one compound A selected from

(a1) a compound of the general formula (I)

R¹R²R³Si—H (I),

in which the radicals R¹, R² and R³ are each independently selected from the group consisting of (i) hydrogen, (ii) halogen, (iii) unsubstituted or substituted C₁-C₂₀-hydrocarbon radical, and (iv) unsubstituted or substituted C₁-C₂₀-hydrocarbonoxy radical, where two of the radicals R¹, R² and R³ may also form with each other a monocyclic or polycyclic, unsubstituted or substituted C₂-C₂₀-hydrocarbon radical, wherein substituted means in each case that the hydrocarbon or hydrocarbonoxy radical each independently has at least one of the following substitutions: a hydrogen atom can be replaced by halogen, —C—N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group can be replaced by —O—, —S— or —NR^{z}—, and a carbon atom can be replaced by a Si atom, in which R^{z} is in each case independently selected from the group consisting of hydrogen, C₁-C₆-alkyl radical, C₆-C₁₄-aryl radical, and C₂-C₆-alkenyl radical; and/or

(a2) a compound of the general formula (I′)

(SiO_{4/2})ₐ(R^{x}SiO_{3/2})_{b}(HSiO_{3/2})_{b′}(R^{x}₂SiO_{2/2})_{c}(R^{x}HSiO_{2/2})_{c′}(H₂SiO_{2/2})_{c″(R}^{x}₃SiO_{1/2})_{d}(HR^{x}₂SiO_{1/2})_{d′}(H₂RₓSiO_{1/2})_{d″}(H₃SiO_{1/2})_{d′″} (I′),

in which the radicals R^{x} are each independently selected from the group consisting of (i) halogen, (ii) unsubstituted or substituted C₁-C₂₀-hydrocarbon radical, and (iii) unsubstituted or substituted C₁-C₂₀-hydrocarbonoxy radical, wherein substituted means in each case that the hydrocarbon or hydrocarbonoxy radical each independently has at least one of the following substitutions: a hydrogen atom can be replaced by halogen, a CH₂ group can be replaced by —O— or —NR^{z}—, in which R^{z} is in each case independently selected from the group consisting of hydrogen, C₁-C₆-alkyl radical, C₆-C₁₄-aryl radical, and C₂-C₆-alkenyl radical; and in which the indices a, b, b′, c, c′, c″, d, d′, d″, d′″ specify the number of the respective siloxane unit in the compound and are each independently an integer in the range from 0 to 100 000, with the proviso that the sum of a, b, b′, c, c′, c″, d, d′, d″, d′″ together has the value of at least 2 and at least one of the indices b′, c′, c″, d′, d″ or d′″ is not equal to 0; and

(b) at least one compound B selected from

(b1) a compound of the general formula (II)

R⁴R⁵R⁶Si—O—R⁷ (II),

in which radicals R⁴, R⁵ and R⁶ are each independently selected from the group consisting of (i) hydrogen, (ii) halogen, (iii) unsubstituted or substituted C₁-C₂₀-hydrocarbon radical, (iv) unsubstituted or substituted O-bonded or C-bonded C₁-C₂₀-hydrocarbonoxy radical, (v) organosilicon radical having 1-100 000 Si atoms, where two of the radicals R⁴, R⁵ and R⁶ may also form with each other a monocyclic or polycyclic, unsubstituted or substituted C₂-C₂₀-hydrocarbon radical, wherein substituted means in each case that the hydrocarbon or hydrocarbonoxy radical each independently has at least one of the following substitutions: a hydrogen atom can be replaced by halogen, —C—N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group can be replaced by —O—, —S— or —NR^{z}—, and a carbon atom can be replaced by a Si atom, in which R^{z} is in each case independently selected from the group consisting of hydrogen, C₁-C₆-alkyl radical, C₆-C₁₄-aryl radical, and C₂-C₆-alkenyl radical;

and in which the radical R⁷ is selected from the group consisting of (i) unsubstituted or substituted C₁-C₂₀-hydrocarbon radical, and (ii) unsubstituted or substituted C-bonded C₁-C₂₀-hydrocarbonoxy radical, wherein substituted means in each case that the hydrocarbon or hydrocarbonoxy radical each independently has at least one of the following substitutions: a hydrogen atom can be replaced by halogen, —C—N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group can be replaced by —O—, —S— or —NR^{z}—, and a carbon atom can be replace by a Si atom, in which R^{z} is in each case independently selected from the group consisting of hydrogen, C₁-C₆-alkyl radical, C₆-C₁₄-aryl radical, and C₂-C₆-alkenyl radical; and/or

(b2) a compound of the general formula (II′)

R^{x}₃Si—O[—SiR^{x}₂—O]ₘ—[Si(OR⁷)R^{x}—O]ₙSiR^{x}₃ (II),

in which the radicals R^{x} are each independently selected from the group consisting of (i) hydrogen, (ii) halogen, (iii) —O—R⁷, (iv) unsubstituted or substituted C₁-C₂₀-hydrocarbon radical, and (v) unsubstituted or substituted, C-bonded C₁-C₂₀-hydrocarbonoxy radical; and in which the radicals R⁷ are in each case independently selected from the group consisting of (i) unsubstituted or substituted C₁-C₂₀-hydrocarbon radical, and (ii) unsubstituted or substituted C-bonded C₁-C₂₀-hydrocarbonoxy radical, wherein substituted means in each case that the hydrocarbon or hydrocarbonoxy radical each independently has at least one of the following substitutions: a hydrogen atom can be replaced by halogen, —C—N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group can be replaced by —O—, —S— or —NR^{z}—, and a carbon atom can be replaced by a Si atom, in which R^{z} is in each case independently selected from the group consisting of hydrogen, C₁-C₆-alkyl radical, C₆-C₁₄-aryl radical, and C₂-C₆-alkenyl radical;

and in which m and n are each independently an integer in the range from 0 to 100 000, with the proviso that at least one group —O—R⁷ is present in the compound; and

(c) at least one compound C selected from cationic germanium(II) compounds of the general formula (III)

([Ge(II)Cp]⁺)ₐX^{a-} (114),

in which Cp is a π-bonded cyclopentadienyl radical of the general formula (IIIa)

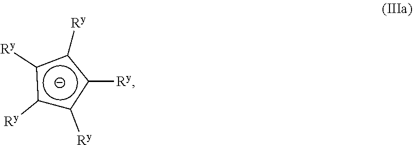

in which the radicals R^{y} are each independently selected from the group consisting of (i) triorganosilyl radical of the formula —SiR^{b}₃, in which the radicals R^{b} are each independently C₁-C₂₀-hydrocarbon radical, (ii) hydrogen, (iii) unsubstituted or substituted C₁-C₂₀-hydrocarbon radical, and (iv) unsubstituted or substituted C₁-C₂₀-hydrocarbonoxy radical, wherein in each case two radicals R^{y} can also form with each other a monocyclic or polycyclic C₂-C₂₀-hydrocarbon radical, and wherein substituted means in each case that in the hydrocarbon or hydrocarbonoxy radical also at least one carbon atom can be replaced by a Si atom,

X^{a-} is an a valent anion; and

a can have the values 1, 2 or 3.

Compound A

At least one compound A is present in the mixture M, which also includes mixtures of compounds of the general formula (I) and/or mixtures of compounds of the general formula (I′).

In formula (I), the radicals R¹, R² and R³ are preferably each independently selected from the group consisting of (i) hydrogen, (ii) chlorine, (iii) unsubstituted or substituted C₁-C₁₄-hydrocarbon radical, and (iv) unsubstituted or substituted C₁-C₁₄-hydrocarbonoxy radical, wherein substituted has in each case the same definition as before; and in formula (I′) the radicals R^{x} are preferably each independently selected from the group consisting of chlorine, C₁-C₆-alkyl radical, C₂-C₆-alkenyl radical, phenyl, and C₁-C₆-alkoxy radical, and the indices a, b, b′, c, c′, c″, d, d′, d″, d′″ are each independently selected from an integer in the range of 0 to 1000.

In formula (I), the radicals R¹, R² and R³ are particularly preferably each independently selected from the group consisting of (i) hydrogen, (ii) chlorine, (iii) C₁-C₆-alkyl radical, (iv) C₂-C₆-alkenyl radical, (v) unsubstituted or substituted C₆-C₁₄-aryl radical, (vi) unsubstituted or substituted C₆-C₁₄-aralkyl radical and (vii) C₁-C₆-alkoxy radical, wherein substituted has in each case the same definition as before; and in formula (I′) the radicals R^{x} are particularly preferably each independently selected from the group consisting of chlorine, methyl, methoxy, ethyl, ethoxy, n-propyl, n-propoxy, and phenyl, and the indices a, b, b′, c, c′, c″, d, d′, d″, d′″ are each independently selected from an integer in the range of 0 to 1000.

A mixture of compounds of the formula (I′) is present, particularly in the case of polysiloxanes. For the sake of simplicity, however, the individual compounds of the mixture are not specified for polysiloxanes, but an average formula (I′a) similar to the formula (I′) is given

(SiO_{4/2})ₐ(R^{x}SiO_{3/2})_{b}(HSiO_{3/2})_{b′}(R^{x}₂SiO_{2/2})_{c}(R^{x}HSiO_{2/2})_{c′}(H₂SiO_{2/2})_{c″}(R^{x}₃SiO_{1/2})_{d}(HR^{x}₂SiO_{1/2})_{d′}(H₂RₓSiO_{1/2})_{d″}(H₃SiO_{1/2})_{d′″} (I′a),

in which the radicals R^{x} have the same definition as in formula (I′), but the indices a, b, b′, c, c′, c″, d, d′, d″, d′″ are each independently a number in the range of 0 to 100 000 and specify the average content of the respective siloxane unit in the mixture. Preference is given to those mixtures of the average formula (I′a), in which the indices a, b, b′, c, c′, c″, d, d′, d″, d′″ are each independently selected from a number in the range of 0 to 20000.

Examples of compounds A of the general formula (I) are the following silanes (Ph=phenyl, Me=methyl, Et=ethyl): Me₃SiH, Et₃SiH, Me₂PhSiH, MePh₂SiH, Me₂ClSiH, Et₂ClSiH, MeCl₂SiH, Cl₃SiH, HMe₂Si-Ph-SiMe₂H, Me₂(MeO)SiH, Me(MeO)₂SiH, (MeO)₃SiH, Me₂(EtO)SiH, Me(EtO)₂SiH, (EtO)₃SiH; and examples of compounds A of the general formula (I′) are the following siloxanes and polysiloxanes: HSiMe₂—O—SiMe₂H, Me₃Si—O—SiHMe₂, Me₃Si—O—SiHMe-O—SiMe₃, H—SiMe₂—(O—SiMe₂)ₘ—O—SiMe₂—H, in which m is a number in the range of 1 to 20 000, Me₃Si—O—(SiMe₂—O)ₙ(SiHMe-O)ₒ—SiMe₃, in which n and o are each independently a number in the range of 1 to 20 000.

Compound B

At least one compound B is present in the mixture M, which also includes mixtures of compounds of the general formula (II) and/or mixtures of compounds of the general formula (II′).

In formula (II), the radicals R⁴, R⁵ and R⁶ are preferably each independently selected from the group consisting of (i) hydrogen, (ii) chlorine, (iii) unsubstituted or substituted C₁-C₁₄-hydrocarbon radical, and (iv) unsubstituted or substituted, O-bonded or C-bonded C₁-C₁₄-hydrocarbonoxy radical, and the radical R⁷ is selected from the group consisting of (i) unsubstituted or substituted C₁-C₆-hydrocarbon radical, and (ii) unsubstituted or substituted C-bonded C₁-C₆-hydrocarbonoxy radical; and in formula (II′) the radicals R^{x} are preferably each independently selected from the group consisting of (i) hydrogen, (ii) chlorine, (iii) —O—R⁷, (iv) unsubstituted or substituted C₁-C₁₄-hydrocarbon radical, and (v) unsubstituted or substituted C-bonded C₁-C₁₄-hydrocarbonoxy radical, and the radicals R⁷ are in each case independently selected from the group consisting of (i) unsubstituted or substituted C₁-C₆-hydrocarbon radical, and (ii) unsubstituted or substituted C-bonded C₁-C₆-hydrocarbonoxy radical.

In formula (II), the radicals R⁴, R⁵ and R⁶ are particularly preferably each independently selected from the group consisting of (i) hydrogen, (ii) chlorine, (iii) C₁-C₆-alkyl radical, (iv) C₁-C₆-alkenyl radical, (v) phenyl radical, and (vi) C₁-C₆-alkoxy radical, and the radical R⁷ is selected from the group consisting of (i) unsubstituted or substituted C₁-C₆-hydrocarbon radical, and (ii) unsubstituted or substituted C-bonded C₁-C₆-hydrocarbonoxy radical; and in formula (II′), the radicals Rx are particularly preferably each independently selected from the group consisting of (i) hydrogen, (ii) chlorine, (iii) C₁-C₆-alkyl radical, (iv) C₁-C₆-alkenyl radical, (v) phenyl radical, (vi) —O—R⁷, and the radicals R⁷ are in each case independently selected from the group consisting of (i) unsubstituted or substituted C₁-C₆-hydrocarbon radical, and (ii) unsubstituted or substituted C-bonded C₁-C₆-hydrocarbonoxy radical.

In formula (II), the radicals R⁴, R⁵ and R⁶ are particularly preferably selected from the group consisting of methyl, ethyl, propyl, phenyl, and chlorine, and R⁷ is selected from the group consisting of methyl, ethyl, propyl, butyl, pentyl; and in formula (II′) the radicals R^{x} are particularly preferably each independently selected from the group consisting of methyl, ethyl, propyl, phenyl, chlorine and —OR⁷, in which the radicals R⁷ are in each case independently selected from the group consisting of methyl, ethyl, propyl, butyl, and pentyl.

Examples of compounds of the formula (II′) are R^{x}₃Si—O[—SiR^{x}₂—O]ₘ—[Si(OR⁷)₂—O]₁₋₁₀₀₀₀₀—SiR^{x}₃, R^{x}₃Si—O[—SiR^{x}₂—O]ₘ—[Si(OR⁷)R)—O]₁₋₁₀₀₀₀₀—SiR^{x}₃, (OR⁷)R^{x}₂Si—O[—SiR^{x}₂—O]ₘ—[Si(OR⁷)R^{x}—O]ₙ—SiR^{x}₃, (OR⁷)R^{x}₂Si—O[—SiR^{x}₂—O]ₘ—[Si(OR⁷)₂—O]ₙ—SiR^{x}₃, (OR⁷)R^{x}₂Si—O[—SiR^{x}₂—O]ₘ—[Si(OR⁷)R^{x}—O]ₙ—SiR^{x}₂(OR⁷), (OR⁷)R^{x}₂Si—O[—SiR^{x}₂—O]ₘ—[Si(OR⁷)₂—O]ₙ—SiR^{x}₂(OR⁷), (OR⁷)₂R^{x}Si—O[—SiR^{x}₂—O]ₘ—[Si(OR⁷)R^{x}—O]ₙ—SiR^{x}₃, (OR⁷)₂R^{x}Si—O[—SiR^{x}₂—O]ₘ—[Si(OR⁷)₂—O]ₙ—SiR^{x}₃, (OR⁷)₂R^{x}Si—O[—SiR^{x}₂—O]ₘ—[Si(OR⁷)R^{x}—O]ₙ—SiR^{x}(OR⁷)₂, (OR⁷)₂R^{x}Si—O[—SiR^{x}₂—O]ₘ—[Si(OR⁷)₂—O]ₙ—SiR^{x}(OR⁷)₂, (OR⁷)₃Si—O[—SiR^{x}₂—O]ₘ—[Si(OR⁷)R^{x}—O]ₙ—SiR^{x}₃, (OR⁷)₃Si—O[—SiR^{x}₂—O]ₘ—[Si(OR⁷)₂—O]ₙ—SiR^{x}₃, (OR⁷)₃Si—O[—SiR^{x}₂—O]ₘ—[Si(OR⁷)R^{x}—O]ₙ—Si(OR⁷)₃, (OR⁷)₃Si—O[—SiR^{x}₂—O]ₘ—[Si(OR⁷)₂—O]ₙ—Si(OR⁷)₃, in which R⁷, R^{x}, m and n have the same definition as in formula (II′).

Examples of compounds B of the general formula (II) are the following silanes (Ph=phenyl, Me=methyl, Et=ethyl):

Me₃SiOEt, Me₃SiOMe, Et₃SiOEt, Et₃SiOMe, Me₂PhSiOEt, Me₂PhSiOMe, MePh₂SiOEt, Me₂Si(OMe)₂, Me₂Si(OEt)₂, Ph₂Si(OMe)₂, Ph₂Si(OEt)₂, MeSi(OMe)₃, MeSi(OEt)₃, PhSi(OMe)₃, Me₂SiH(OMe), Ph₂SiH(OMe), Me₂SiH(OEt), Ph₂SiH(Et), Si(OMe)₄, Si(OEt)₄, isooctyltriethoxysilane, isooctyltrimethoxysilane.

Examples of compounds of the general formula (II′) are the following siloxanes and polysiloxanes:

Me₃Si—O—SiMe₂OMe, Me₃Si—O—SiMe₂OEt, EtOSiMe₂—O—SiMe₂OEt, (MeO)₂SiMe-O—SiMe(OMe)₂, (EtO)₂SiMe-O—SiMe(OEt)₂, (MeO)₃Si—O—Si(OMe)₃, (EtO)₃Si—O—Si(OEt)₃, Me₃Si—O—SiMe(OMe)-O—SiMe₃, Me₃Si—O—SiMe(OEt)-O—SiMe₃, MeO—SiMe₂—(O—SiMe₂)ₘ—O—SiMe₂—OMe and EtO—SiMe₂—(O—SiMe₂)ₘ—O—SiMe₂—OEt where m=1-20 000, Me₃Si—O—(SiMe₂—O)ₙ(SiMe(OMe)-O)ₒ—SiMe₃ and Me₃Si—O—(SiMe₂-0)ₙ(SiMe(OEt)-O)ₒ—SiMe₃ where n=1-20 000 and o=1-20000.

In a particular embodiment, the compound A and the compound B are present in one molecule. Such molecules are, for example, compounds of the general formula (II) in which at least one radical R⁴, R⁵, R⁶ is hydrogen, or compounds of the general formula (II′) in which at least one radical R^{x} is hydrogen.

Examples of such molecules are

dimethylethoxysilane, dimethylmethoxysilane, diphenylmethoxysilane, diphenylethoxysilane, methyldiethoxysilane, methyldimethoxysilane.

Compound C

Examples of radicals R^{y} in formula (III) are alkyl radicals, such as the methyl, ethyl, n-propyl, isopropyl, n-butyl, sec-butyl, isobutyl, tert-butyl, n-pentyl, sec-pentyl, isopentyl, neopentyl and tert-pentyl radical; hexyl radicals such as the n-hexyl radical; heptyl radicals such as the n-heptyl radical; octyl radicals such as the n-octyl radical, and isooctyl radicals such as the 2,4,4-trimethylpentyl radical; nonyl radicals such as the n-nonyl radical; decyl radicals such as the n-decyl radical; dodecyl radicals such as the n-dodecyl radical; hexadecyl radicals such as the n-hexadecyl radical; octadecyl radicals such as the n-octadecyl radical; cycloalkyl radicals, such as the cyclopentyl, cyclohexyl, cycloheptyl radical and methylcyclohexyl radical; aryl radicals, such as the phenyl, naphthyl, anthracene and phenanthrene radical; alkaryl radicals, such as the o-, m- and p-tolyl, xylyl, mesitylenyl and o-, m- and p-ethylphenyl radical; alkaryl radicals, such as the benzyl radical, the a- and the (3-phenylethyl radical; and alkylsilyl radicals such as trimethylsilyl, triethylsilyl, tripropylsilyl, dimethylethylsilyl, dimethyltert-butylsilyl and diethylmethylsilyl radical.

In formula (III), the radicals R^{y} are preferably each independently selected from the group consisting of (i) C₁-C₃-alkyl radical, (ii) hydrogen and (iii) triorganosilyl radical of the formula —SiR^{b}₃, in which the radicals R^{b} are each independently a C₁-C₂₀-alkyl radical. The radicals R^{y} are particularly preferably each independently selected from the methyl radical and trimethylsilyl radical. All radicals R^{y} are especially preferably a methyl radical.

The index a in formula (III) is preferably 1, so that X⁻ is a monovalent anion.

Examples of anions X⁻ are:

halides;

chlorate ClO₄⁻;

tetrachlorometalates [MCl₄]⁻ where M=Al, Ga;

tetrafluoroborate [BF₄]⁻;

trichlorometalates [MCl₃]⁻ where M=Sn, Ge;

hexafluorometalates [MF₆]⁻ where M=As, Sb, Ir, Pt; perfluoroantimonates [Sb₂F₁₁]⁻, [Sb₃F₁₆]⁻ and [Sb₄F₂₁]⁻;

triflate (=trifluoromethanesulfonate) [OSO₂CF₃]⁻;

tetrakis(trifluoromethyl)borate [B(CF₃)₄]⁻; tetrakis(pentafluorophenyl) metalates [M(C₆F₅)₄]— where M=Al, Ga;

tetrakis(pentachlorophenyl)borate [B(C₆Cl₅)₄]⁻;

tetrakis[(2,4,6-trifluoromethyl (phenyl)]borate {B[C₆H₂(CF₃)₃]}⁻;

[bis[tris(pentafluorophenyl)] hydroxide {HO[B(C₆F₅)₃]₂};

closo-carborates [CHB₁₁H₅Cl₆]⁻, [CHB₁₁H₅Br₆]⁻, [CHB₁₁(CH₃)₅Br₆]⁻, [CHB₁₁F₁₁]⁻, [C(Et)B₁₁F₁₁]⁻, [CB₁₁(CF₃)₁₂]⁻ and B₁₂Cl₁₁N(CH₃)₃]⁻;

tetra(perfluoroalkoxy)aluminates [Al(OR^{PF})₄]⁻ where R^{PF}=each independently perfluorinated C₁-C₁₄-hydrocarbon radical;

tris(perfluoroalkoxy)fluoroaluminates [FAl(OR^{PF})₃]⁻ where R^{PF}=each independently perfluorinated C₁-C₁₄-hydrocarbon radical;

hexakis(oxypentafluorooxotellurato) antimonate [Sb(OTeF₅)₆]⁻;

borates and aluminates of the formulae [B(R^{a})₄]⁻ and [Al(R^{a})₄]⁻, in which the radicals R^{a} are each independently selected from aromatic C₆-C₁₄-hydrocarbon radicals, in which at least one hydrogen atom has been mutually independently substituted by a radical selected from the group consisting of (i) fluorine, (ii) perfluorinated C₁-C₆-alkyl radical, and (iii) triorganosilyl radical of the formula —SiR^{b}₃, in which the radicals R^{b} are each independently C₁-C₂₀-alkyl radicals.

In formula (III), the anions X— are preferably selected from the group consisting of the compounds of the formulae [B(R^{a})₄]⁻ and [Al(R^{a})₄]⁻, in which the radicals R^{a} are in each case independently selected from aromatic C₆-C₁₄-hydrocarbon radicals in which at least one hydrogen atom has been mutually independently substituted by a radical selected from the group consisting of (i) fluorine, (ii) perfluorinated C₁-C₆-alkyl radical, and (iii) triorganosilyl radical of the formula —SiR^{b}₃, in which the radicals R^{b} are each independently C₁-C₂₀-alkyl radicals.

Examples of radicals R^{a} are the m-difluorophenyl radical, 2,2,4,4-tetrafluorophenyl radical, perfluorinated 1-naphthyl radical, perfluorinated 2-naphthyl radical, perfluorobiphenyl radical, —C₆F₅, —C₆H₃(m-CF₃)₂, —C₆H₄(p-CF₃), —C₆H₂(2,4,6-CF₃)₃, —C₆F₃(m-SiMe₃)₂, —C₆F₄(p-SiMe₃), —C₆F₄(p-SiMe₂t-butyl).

In formula (III), the anions X— are particularly preferably selected from the group consisting of the compounds of the formula [B(R^{a})₄]⁻, in which the radicals R^{a} are each independently selected from aromatic C₆-C₁₄-hydrocarbon radicals, in which all hydrogen atoms have been mutually independently substituted by a radical selected from the group consisting of (i) fluorine and (ii) triorganosilyl radical of the formula —SiR^{b}₃, in which the radicals Re are each independently C₁-C₂₀-alkyl radicals.

In formula (III), the anions X— are especially preferably selected from the group consisting of the compounds of the formula [B(R^{a})₄]⁻, in which the radicals R^{a} are each independently selected from the group consisting of —C₆F₅, perfluorinated 1- and 2-naphthyl radical, —C₆F₃(SiR^{b}₃)₂ and —C₆F₄(SiR^{b}₃), in which the radicals Re are in each case independently C₁-C₂₀-alkyl radicals.

In formula (III), the anions X— are most preferably selected from the group consisting of [B(C₆F₅)₄]⁻, [B(C₆F₄(4-TBS)₄]⁻ where TBS=SiMe₂tert-butyl, [B(2-NaphF)₄]⁻ where 2-NaphF=perfluorinated 2-naphthyl radical and [B(C₆F₅)₃(2-NaphF)]⁻ where 2-NaphF=perfluorinated 2-naphthyl radical.

Preferred compounds of the formula (III) are those in which all radicals R^{y} are methyl and the anions X— are selected from the group consisting of the compounds of the formulae [B(R^{a})₄]⁻, in which the radicals R^{a} are each independently selected from aromatic C₆-C₁₄-hydrocarbon radicals, in which at least one hydrogen atom has been mutually independently substituted by a radical selected from the group consisting of (i) fluorine, (ii) perfluorinated C₁-C₆-alkyl radical, and (iii) triorganosilyl radical of the formula —SiR^{b}₃, in which the radicals R^{b} are each independently C₁-C₂₀-alkyl radicals.

The compounds of the formula (III) are particularly preferably selected from the group consisting of Cp*Ge⁺B (C₆F₅)₄⁻; Cp*Ge⁺B[C₆F₄(4-TBS)]₄⁻, where TBS=SiMe₂tert-butyl; Cp*Ge⁺B(2-NaphF)₄⁻, where 2-NaphF=perfluorinated 2-naphthyl radical; and Cp*Ge⁺B[(C₆F₅)₃(2-NaphF)]⁻, where 2-NaphF=perfluorinated 2-naphthyl radical.

The mixture M according to the invention may comprise any additional compounds such as processing aids, e.g. emulsifiers, fillers, for example highly dispersed silica or quartz, stabilizers, for example free radical inhibitors, pigments, for example dyes, or white pigments, for example chalk or titanium dioxide. The amounts of the further compounds are preferably between 0.1% by weight and 95% by weight, particularly preferably between 1% by weight and 80% by weight, very particularly preferably between 5% by weight and 30% by weight, based in each case on the total weight of the mixture M.

The invention further relates to a process for preparing siloxanes by means of a Piers-Rubinsztajn reaction of the mixture M according to the invention, wherein at least one compound A is reacted with at least one compound B in the presence of at least one compound C and in the presence of oxygen.

The amount of oxygen is not critical in the Piers-Rubinsztajn reaction; any oxygen-containing gas mixture known to those skilled in the art, such as ambient air, lean air, etc., can be used. The oxygen preferably comes from an oxygen-containing gas mixture having an oxygen content of 0.1-100% by volume.

It is also not critical when and how the oxygen is added. The oxygen-containing gas can, for example, be added once into the gas space, or it can be introduced continuously, or it can, prior to addition thereof, be passed over the cationic germanium(II) compound, or it can be introduced into a solution of the cationic germanium(II) compound, or it can be brought into contact with the reaction mixture via other methods known to those skilled in the art.

The reactants can be mixed with one another in any sequence, the mixing taking place in a manner known to those skilled in the art. For example, the compounds A, B and C can be mixed so that the Piers-Rubinsztajn reaction is initiated by contact with oxygen. It is also possible to first mix the compounds A and B or A and C or B and C and then to add the missing compound. In addition, according to a preferred embodiment, one molecule which comprises the compounds A and B can be used. These may be, for example, the corresponding preferred compounds B which comprise at least one hydrogen atom and which are specified in more detail above.

In a particular embodiment, the Piers-Rubinsztajn reaction of the mixture M according to the invention is carried out under an air, lean air or oxygen atmosphere.

In a further particular embodiment, a solution of compound C is brought into contact with oxygen and mixed with compound A and compound B at a later point in time.

The molar ratio between the available hydrogen atoms directly bonded to silicon and alkoxy moieties directly bonded to silicon is typically in the range from 1:100 to 100:1, the molar ratio preferably being in the range from 1:10 to 10:1, particularly preferably in the range 1:2 to 2:1.

The molar proportion of the cationic germanium(II) compound C relative to the Si—H moieties present in compound A is preferably in the range from 0.0001 mol % to 10 mol %, particularly preferably in the range from 0.001 mol % up to 1 mol %, very particularly preferably in the range from 0.01 mol % to 0.1 mol %.

The Piers-Rubinsztajn reaction can be carried out without solvent or with the addition of one or more solvents. The proportion of the solvent or solvent mixture relative to the compound A is preferably at least 0.01% by weight and at most 1000-fold the weight, particularly preferably at least 1% by weight and at most 100-fold the weight, especially preferably at least 10% by weight and at most 10-fold the weight.

Solvents used may preferably be aprotic solvents, for example hydrocarbons such as pentane, hexane, heptane, cyclohexane or toluene, chlorinated hydrocarbons such as dichloromethane, chloroform, chlorobenzene or 1,2-dichloroethane, ethers such as diethyl ether, methyl tert-butyl ether, anisole, tetrahydrofuran or dioxane, or nitriles such as for example acetonitrile or propionitrile.

Preference is given to solvents or solvent mixtures with a boiling point or boiling range of up to 120° C. at 0.1 MPa.

Preferred solvents are aromatic or aliphatic hydrocarbons.

The pressure in the Piers-Rubinsztajn reaction can be freely selected by those skilled in the art; it can be carried out under ambient pressure or under reduced or elevated pressure. The pressure is preferably in a range from 0.01 bar to 100 bar, particularly preferably in a range from 0.1 bar to 10 bar, the Piers-Rubinsztajn reaction being very particularly preferably carried out at ambient pressure. If, however, compounds are involved in the Piers-Rubinsztajn reaction that are present in gaseous form at the reaction temperature, the reaction is preferably carried out at elevated pressure, particularly preferably at the vapor pressure of the overall system.

The person skilled in the art can freely select the temperature of the Piers-Rubinsztajn reaction. It is preferably carried out at a temperature in the range from +40° C. to +200° C., particularly preferably in the range from +50° C. to +150° C., very particularly preferably in the range from +60° C. to +120° C.

In a further embodiment, a compound A is used which comprises more than one Si—H moiety, and a compound B which comprises more than one silicon-alkoxy moiety. According to a preferred embodiment, it is also possible to use one molecule which comprises both compound A (Si—H moieties) and compound B (Si-alkoxy moieties). In this way, copolymers can be obtained.

The process according to the invention can be used, for example, to remove small amounts of Si-alkoxy moieties that are present in products as labile impurities and that are therefore often disruptive in applications, and that have been produced by other processes, for example hydrolytic condensation reactions, by reacting these with a compound A in the presence of compound C and oxygen.

The labile Si-alkoxy moieties are converted here into inert Si—O—Si moieties. In an analogous manner, products which still contain undesired Si—H moieties, for example from hydrosilylation reactions, can also be reacted by reacting a compound B in the presence of compound C and oxygen.

The invention also relates to the use of the cationic germanium(II) compounds according to formula (III) as catalyst for Piers-Rubinsztajn reactions.

Particular preference is given to the use of the cationic germanium(II) compounds according to formula (IV) as catalyst for Piers-Rubinsztajn reactions.

### EXAMPLES

Preparation of Cp*Ge⁺B(C₆F₅)₄⁻

Under an argon atmosphere, 701 mg (2.04 mmol) of decamethylgermanocene (Cp*₂Ge, Cp*=pentamethylcyclopentadienyl) were dissolved in 5 ml of dichloromethane and a solution of 1.70 g (1.83 mmol) of (C₆H₅)₃C⁺B(C₆F₅)₄⁻ in 5 ml of dichloromethane was added slowly at room temperature with shaking. Subsequently, enough heptane was added as precipitant until no further precipitation of the product took place. The supernatant solution was decanted off, the precipitate was redissolved in dichloromethane and again precipitated with heptane. The precipitated product was filtered off under suction and dried, finally under high vacuum.

Yield: 1.63 g (97%), pale pink solid.

¹H-NMR (CD₂Cl₂): δ=2.23 (methyl groups).

¹³C-NMR (CD₂Cl₂): δ=8.82 (methyl groups), δ=123.1 (C's Cp*-Ring), δ=124 (broad), δ=135.3 (m), δ=137.3 (m), δ=139.2 (m), δ=147.2 (m), δ=149.1 (m): aromatic C—F.

¹¹B-NMR (CD₂Cl₂): δ=−16.66 (s).

¹⁹F-NMR (CD₂Cl₂): δ=−167.4 (mc, 8 ortho-F), δ=−163.5 (mc, 4 para-F), δ=−132.9 (m, broad, 8 meta-F).

### Example 1

Oxygen was passed for 3 hours into a solution of 0.30 mg (0.45 μmol) of (π-Me₅C₅)Ge⁺B(C₆F₅)₄⁻ in 475 mg of dichloromethane. 178 mg (0.650 mmol) of diethoxydiphenylsilane and 101 mg (0.752 mmol) of 1,1,3,3-tetramethyldisiloxane were then added to this solution, and the mixture was heated to 60° C. for 8 hours. The solvent was then removed under high vacuum. The residue was a colorless, highly viscous oil.

GPC: M_{w}=20 700, Mₙ=6800, M_{w}/Mₙ=3.00.

### Example 2

160 mg (0.587 mmol) of diethoxydiphenylsilane and 101 mg (0.660 mmol) of 1,4-bis(dimethylsilyl)benzene were added to a solution of 0.30 mg (0.45 μmol) of (π-Me₅C₅)Ge⁺B(C₆F₅)₄⁻ in 800 mg of dichloromethane, 3×3 ml of air were injected by syringe and the mixture was heated to 70° C. for 4 hours. The solvent was then removed under high vacuum.

The residue was a colorless, highly viscous oil.

GPC: M_{w}=14 600, Mₙ=5700, M_{w}/Mₙ=2.57.

### Example 3

341 mg (1.25 mmol) of diethoxydiphenylsilane and 361 mg (2.43 mmol) of pentamethyldisiloxane were added to a solution of 0.4 mg (0.5 μmol) of (π-Me₅C₅)Ge⁺B(C₆F₅)₄⁻ in 1020 mg of dichloromethane, 3×3 ml of air were injected by syringe and the mixture was heated to 50° C. for 2 hours. The main product of the reaction is 1,1,1,3,3,7,7,9,9,9-decamethyl-5,5-diphenylpentasiloxane. ²⁹Si-NMR (CD₂Cl₂): δ=−48.2 (SiPh₂), −20.2 (2 TMS-SiMe₂), 7.74 (2 Me₃Si). GC-MS: m/z=508 (1%, M⁺), 493 (15%, M⁺-CH₃).

1-17. (canceled)

18. A mixture M, comprising:
(a) at least one compound A selected from
(a1) a compound of the general formula (I)
R¹R²R³Si—H (I),
in which the radicals R¹, R² and R³ are each independently selected from the group consisting of (i) hydrogen, (ii) halogen, (iii) unsubstituted or substituted C₁-C₂₀-hydrocarbon radical, and (iv) unsubstituted or substituted C₁-C₂₀-hydrocarbonoxy radical, where two of the radicals R¹, R² and R³ may also form with each other a monocyclic or polycyclic, unsubstituted or substituted C₂-C₂₀-hydrocarbon radical, wherein substituted means in each case that the hydrocarbon or hydrocarbonoxy radical each independently has at least one of the following substitutions: a hydrogen atom can be replaced by halogen, —C—N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group can be replaced by —O—, —S— or —NR^{z}—, and a carbon atom can be replaced by a Si atom, in which R^{z} is in each case independently selected from the group consisting of hydrogen, C₁-C₆-alkyl radical, C₆-C₁₄-aryl radical, and C₂-C₆-alkenyl radical; and/or
(a2) a compound of the general formula (I′)
(SiO_{4/2})ₐ(R^{x}SiO_{3/2})_{b}(HSiO_{3/2})_{b′}(R^{x}₂SiO_{2/2})_{c}(R^{x}HSiO_{2/2})_{c′}(H₂SiO_{2/2})_{c″}(R^{x}₃SiO_{2/2})ₐ(HR^{x}₂SiO_{1/2})_{d}(H₂R^{x}SiO_{1/2})_{d″}(H₃SiO_{1/2})_{d′″} (I′),
in which the radicals R^{x} are each independently selected from the group consisting of (i) halogen, (ii) unsubstituted or substituted C₁-C₂₀-hydrocarbon radical, and (iii) unsubstituted or substituted C₁-C₂₀-hydrocarbonoxy radical, wherein substituted means in each case that the hydrocarbon or hydrocarbonoxy radical each independently has at least one of the following substitutions: a hydrogen atom can be replaced by halogen, a CH₂ group can be replaced by —O— or —NR^{z}—, in which R^{z} is in each case independently selected from the group consisting of hydrogen, C₁-C₆-alkyl radical, C₆-C₁₄-aryl radical, and C₂-C₆-alkenyl radical; and in which the indices a, b, b′, c, c′, c″, d, d′, d″, d′″ specify the number of the respective siloxane unit in the compound and are each independently an integer in the range from 0 to 100 000, with the proviso that the sum of a, b, b′, c, c′, c″, d, d′, d″, d″ together has the value of at least 2 and at least one of the indices b′, c′, c″, d′, d″ or d′″ is not equal to 0; and
(b) at least one compound B selected from
(b1) a compound of the general formula (II)
R⁴R⁵R⁶Si—O—R⁷ (II),
in which radicals R⁴, R⁵ and R⁶ are each independently selected from the group consisting of (i) hydrogen, (ii) halogen, (iii) unsubstituted or substituted C₁-C₂₀-hydrocarbon radical, (iv) unsubstituted or substituted, 0-bonded or C-bonded C₁-C₂₀-hydrocarbonoxy radical, (v) organosilicon radical having 1-100 000 Si atoms, where two of the radicals R⁴, R⁵ and R⁶ may also form with each other a monocyclic or polycyclic, unsubstituted or substituted C₂-C₂₀-hydrocarbon radical, wherein substituted means in each case that the hydrocarbon or hydrocarbonoxy radical each independently has at least one of the following substitutions: a hydrogen atom can be replaced by halogen, —C—N, —OR^{z}, —SR^{z}—NR^{z}₂—PR^{z}₂, —O—CO—R^{z}, —NH—CO—R^{z}, —O—CO—OR^{z} or —COOR^{z}, a CH₂ group can be replaced by —O—, —S— or —NR^{z}—, and a carbon atom can be replaced by a Si atom, in which R^{z} is in each case independently selected from the group consisting of hydrogen, C₁-C₆-alkyl radical, C₆-C₁₄-aryl radical, and C₂-C₆-alkenyl radical; and in which the radical R⁷ is selected from the group consisting of (i) unsubstituted or substituted C₁-C₂₀-hydrocarbon radical, and (ii) unsubstituted or substituted C-bonded C₁-C₂₀-hydrocarbonoxy radical, wherein substituted means in each case that the hydrocarbon or hydrocarbonoxy radical each independently has at least one of the following substitutions: a hydrogen atom can be replaced by halogen, —C—N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group can be replaced by —O—, —S— or —NR^{z}—, and a carbon atom can be replace by a Si atom, in which R^{z} is in each case independently selected from the group consisting of hydrogen, C₁-C₆-alkyl radical, C₆-C₁₄-aryl radical, and C₂-C₆-alkenyl radical; and/or
(b2) a compound of the general formula (II′)
R^{x}₃Si—O[—SiR^{x}₂—O]ₘ—[Si(OR⁷₃)R^{x}—O]ₙ—SiR^{x}₃ (II′),
in which the radicals R^{x} are each independently selected from the group consisting of (i) hydrogen, (ii) halogen, (iii) —O—R⁷, (iv) unsubstituted or substituted C₁-C₂₀-hydrocarbon radical, and (v) unsubstituted or substituted, C-bonded C₁-C₂₀-hydrocarbonoxy radical; and in which the radicals R⁷ are in each case independently selected from the group consisting of (i) unsubstituted or substituted C₁-C₂₀-hydrocarbon radical and (ii) unsubstituted or substituted C-bonded C₁-C₂₀-hydrocarbonoxy radical, wherein substituted means in each case that the hydrocarbon or hydrocarbonoxy radical each independently has at least one of the following substitutions: a hydrogen atom can be replaced by halogen, —C—N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group can be replaced by —O—, —S— or —NR^{z}—, and a carbon atom can be replaced by a Si atom, in which R^{z} is in each case independently selected from the group consisting of hydrogen, C₁-C₆-alkyl radical, C₆-C₁₄-aryl radical, and C₂-C₆-alkenyl radical; and in which m and n are each independently an integer in the range from 0 to 100 000, with the proviso that at least one group —O—R⁷ is present in the compound; and
(c) at least one compound C selected from the cationic germanium(II) compound of the general formula (III)
([Ge(II)Cp]⁺)ₐX^{a-} (III),
in which Cp is a π-bonded cyclopentadienyl radical of the general formula (Ilia) 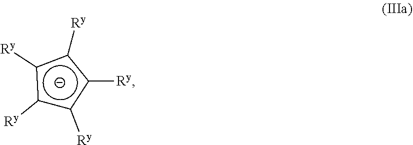
in which the radicals R^{y} are each independently selected from the group consisting of (i) triorganosilyl radical of the formula —SiR^{b}₃, in which the radicals R^{b} are each independently C₁-C₂₀-hydrocarbon radical, (ii) hydrogen, (iii) unsubstituted or substituted C₁-C₂₀-hydrocarbon radical, and (iv) unsubstituted or substituted C₁-C₂₀-hydrocarbonoxy radical, wherein in each case two radicals R^{y} can also form with each other a monocyclic or polycyclic C₂-C₂₀-hydrocarbon radical, wherein substituted means in each case that in the hydrocarbon or hydrocarbonoxy radical also at least one carbon atom can be replaced by a Si atom,
X^{a-} is an a valent anion; and
a can have the values 1, 2 or 3.

19. The mixture M as claimed in claim 18, wherein in formula (I) the radicals R¹, R² and R³ are each independently selected from the group consisting of (i) hydrogen, (ii) chlorine, (iii) unsubstituted or substituted C₁-C₁₂-hydrocarbon radical, and (iv) unsubstituted or substituted C₁-C₁₂-hydrocarbonoxy radical, wherein substituted has the same definition as before; and in formula (I′) the radicals R^{x} are each independently selected from the group consisting of chlorine, C₁-C₆-alkyl radical, C₂-C₆-alkenyl radical, phenyl, and C₁-C₆-alkoxy radical, and the indices a, b, b′, c, c′, c″, d, d′, d″, d′″ are each independently selected from an integer in the range of 0 to 1.

20. The mixture M as claimed in claim 19, wherein in formula (I) the radicals R¹, R² and R³ are each independently selected from the group consisting of (i) hydrogen, (ii) chlorine, (iii) C₁-C₆-alkyl radical, (iv) C₂-C₆-alkenyl radical, (v) unsubstituted or substituted phenyl radical, and (vi) C₁-C₆-alkoxy radical; and in formula (I′) the radicals R^{x} are each independently selected from the group consisting of chlorine, methyl, methoxy, ethyl, ethoxy, n-propyl, n-propoxy, and phenyl, and the indices a, b, b′, c, c′, c″, d, d′, d″, d′″ are each independently selected from an integer in the range from 0 to 1000.

21. The mixture M as claimed in claim 20, wherein in formula (I) the radicals R¹, R² and R³ and in formula (I′) the radicals R^{x} are each independently selected from the group consisting of hydrogen, chlorine, methyl, methoxy, ethyl, ethoxy, n-propyl, n-propoxy, and phenyl, and the indices a, b, b′, c, c′, c″, d, d′, d″, d′″ are each independently selected from an integer in the range from 0 to 1000.

22. The mixture M as claimed in claim 18, wherein in formula (II) the radicals R⁴, R⁵ and R⁶ are each independently selected from the group consisting of (i) hydrogen, (ii) chlorine, (iii) unsubstituted or substituted C₁-C₁₄-hydrocarbon radical, and (iv) unsubstituted or substituted, O-bonded or C-bonded C₁-C₁₄-hydrocarbonoxy radical, and the radical R⁷ is selected from the group consisting of (i) unsubstituted or substituted C₁-C₆-hydrocarbon radical, and (ii) unsubstituted or substituted C-bonded C₁-C₆-hydrocarbonoxy radical; and wherein in formula (II′) the radicals R^{x} are each independently selected from the group consisting of (i) hydrogen, (ii) chlorine, (iii) —O—R⁷, (iv) unsubstituted or substituted C₁-C₁₄-hydrocarbon radical, and (v) unsubstituted or substituted C-bonded C₁-C₁₄-hydrocarbonoxy radical, and the radicals R⁷ are in each case independently selected from the group consisting of (i) unsubstituted or substituted C₁-C₆-hydrocarbon radical, and (ii) unsubstituted or substituted C-bonded C₁-C₆-hydrocarbonoxy radical.

23. The mixture M as claimed in claim 22, wherein in formula (II) the radicals R⁴, R⁵ and R⁶ are each independently selected from the group consisting of (i) hydrogen, (ii) chlorine, (iii) C₁-C₆-alkyl radical, (iv) C₁-C₆-alkenyl radical, (v) phenyl radical, and (vi) C₁-C₆-alkoxy radical, and the radical R⁷ is selected from the group consisting of (i) unsubstituted or substituted C₁-C₆-hydrocarbon radical, and (ii) unsubstituted or substituted C-bonded C₁-C₆-hydrocarbonoxy radical; and in which in formula (II′) the radicals R^{x} are each independently selected from the group consisting of (i) hydrogen, (ii) chlorine, (iii) C₁-C₆-alkyl radical, (iv) C₁-C₆-alkenyl radical, (v) phenyl radical, (vi) —O—R⁷, and the radicals R⁷ are in each case independently selected from the group consisting of (i) unsubstituted or substituted C₁-C₆-hydrocarbon radical, and (ii) unsubstituted or substituted C-bonded C₁-C₆-hydrocarbonoxy radical.

24. The mixture M as claimed in claim 18, wherein in formula (III) the radicals R^{y} are each independently selected from the group consisting of (i) C₁-C₃-alkyl radical and (ii) triorganosilyl radical of the formula —SiR^{b}₃, in which the radicals R^{b} are each independently C₁-C₂₀-alkyl radicals.

25. The mixture M as claimed in claim 24, wherein in formula (III) the anions X— are selected from the group consisting of the compounds of the formulae [B(R^{a})₄]⁻ and [Al(R^{a})₄]⁻, in which the radicals R^{a} are in each case independently selected from aromatic C₆-C₁₄-hydrocarbon radicals in which at least one hydrogen atom has been mutually independently substituted by a radical selected from the group consisting of (i) fluorine, (ii) perfluorinated C₁-C₆-alkyl radical, and (iii) triorganosilyl radical of the formula —SiR^{b}₃, in which the radicals R^{b} are each independently C₁-C₂₀-alkyl radicals.

26. The mixture M as claimed in claim 25, wherein in formula (III) all radicals R^{y} are methyl and the anions X— are selected from the group consisting of the compounds of the formula [B(R^{a})₄]⁻, in which the radicals R^{a} are each independently selected from aromatic C₆-C₁₄-hydrocarbon radicals in which all hydrogen atoms have been mutually independently substituted by a radical selected from the group consisting of (i) fluorine and (ii) triorganosilyl radicals of the formula —SiR^{b}₃, in which the radicals R^{b} are each independently C₁-C₂₀-alkyl radicals.

27. The mixture M as claimed in claim 26, wherein the compound C is selected from the group consisting of Cp*Ge⁺B(C₆F₅)₄; Cp*Ge⁺B[C₆F₄(4-TBS)]₄, where TBS=SiMe₂tert-butyl; Cp*Ge⁺B(2-NaphF)₄, where 2-NaphF=perfluorinated 2-naphthyl radical; and Cp*Ge⁺B[(C₆F₅)₃(2-NaphF)]⁻, where 2-NaphF=perfluorinated 2-naphthyl radical.

28. A process for preparing siloxanes by means of a Piers-Rubinsztajn reaction of the mixture M as claimed in claim 18, wherein at least one compound A is reacted with at least one compound B in the presence of at least one compound C and in the presence of oxygen.

29. The process as claimed in claim 28, wherein the temperature is in a range from +40° C. to +200° C. and the pressure is in a range from 0.01 bar to 100 bar.

30. The process as claimed in claim 28, wherein the oxygen originates from an oxygen-containing gas mixture having an oxygen content of 0.1-100% by volume.

31. The process as claimed in claim 30, wherein the reaction is carried out under an air, lean air or oxygen atmosphere.

32. The process as claimed in claim 28, wherein the molar proportion of cationic germanium(II) compound with respect to the Si—H moieties present in the compound A is in a range from 0.001 mol % to 10 mol %.

33. The use of cationic germanium(II) compounds of the general formula (III) as catalyst for Piers-Rubinsztajn reactions.

34. The use as claimed in claim 33, wherein the cationic germanium(II) compound is one of the general formula (IV).
